(19) United States
(12) Patent Application Publication
(10) Pub. No.: US 2018/0204572 A1
(43) Pub. Date: Jul. 19, 2018

(54) DIALOG DEVICE AND DIALOG METHOD

(71) Applicant: DENSO CORPORATION, Kariya-city, Aichi-pref. (JP)

(72) Inventors: Makoto MANABE, Kariya-city (JP); Toru NADA, Kariya-city (JP); Takuya IWASA, Kariya-city (JP)

(21) Appl. No.: 15/744,258

(22) PCT Filed: Sep. 23, 2016
(86) PCT No.: PCT/JP2016/077972

§ 371 Date: Jan. 12, 2018

(30) Foreign Application Priority Data
Sep. 28, 2015 (JP) 2015-189974

(51) Int. Cl. G10L 15/22; G10L 15/08; G10L 15/30; G10L 13/04

(52) U.S. Cl. CPC G10L 15/22; G10L 15/08; G10L 15/30; G10L 2015/227; G10L 2015/088; G10L 2015/223; G10L 2015/228; G10L 13/043

(57) ABSTRACT

A dialog device, which is mounted in a vehicle together with a speech output unit for outputting a sound in a compartment of the vehicle, and executes a dialog with a driver of the vehicle, is provided. The dialog device includes: a control circuit that generates a conversational sentence toward the driver, and controls the speech output unit to outputs the conversational sentence; and a state information processing circuit that determines whether a driving load on the driver is high with respect to a road where the vehicle travels. The control circuit sets a forbidden state for forbidding from starting utterance, and sets a permitted state for permitting to start the utterance when the state information processing circuit determines that the driving load is low.

### CROSS REFERENCE TO RELATED APPLICATION

This application is based on Japanese Patent Application No. 2015-189974 filed on Sep. 28, 2015, the disclosure of which is incorporated herein by reference.

### TECHNICAL FIELD

The present disclosure relates to a dialog device that is mounted in a vehicle and interacts with a driver of the vehicle, and a dialog method.

### BACKGROUND ART

A conventional topic providing device disclosed in, for example, Patent Literature 1 does not passively reply to a question from a driver, but can actively speak to the driver. For example when a drowsy state of the driver is detected or an obstacle around the vehicle is detected, or in some other case, this topic providing device can output, from a speaker, speech of a topic on the drowsiness or the obstacle.

### PRIOR ART LITERATURES

### Patent Literature

Patent Literature 1: JP-H08-329400-A

### SUMMARY OF INVENTION

However, the topic providing device of Patent Literature 1 undesirably starts speaking to the driver without considering a situation of a driving load on the driver. For example, when the driver nearly comes into a drowsy state, output of speech can be started from the speaker regardless of whether the driving load is high. When an obstacle is detected, output of speech can be started from the speaker despite that the driving load has become high to deal with the obstacle. In such cases as above, there has been a risk for the speech outputted by the topic providing device to interfere with the driver's driving operation.

In view of such circumstances, is an object of the present disclosure to provide a dialog device and a dialog method which are capable of speaking to a driver from the dialog device side without interfering with the driver's driving operation.

According to an aspect of the present disclosure, a dialog device that is mounted in a vehicle together with a speech output unit for outputting a sound in a compartment of the vehicle, and executes a dialog with a driver of the vehicle, the dialog device includes: a dialog execution unit that generates a conversational sentence toward the driver, and controls the speech output unit to outputs the conversational sentence; a load determination unit that determines whether a driving load on the driver is high with respect to a road where the vehicle travels; and an utterance control unit that sets a forbidden state for forbidding the dialog execution unit from starting utterance when the load determination unit determines that the driving load is high, and sets a permitted state for permitting the dialog execution unit to start the utterance when the load determination unit determines that the driving load is low.

According to this dialog device, utterance of conversational sentences by the speech output unit is permitted when the driving load on the driver is low, whereas utterance of conversational sentences is forbidden when the driving load on the driver is high. As described above, by consideration of the situation of the driving load on the driver, the dialog device can speak to the driver from the dialog device side without interfering with the driver's driving operation.

According to an aspect of the present disclosure, a dialog method for executing a dialog with a driver of a vehicle using a speech output unit that outputs a sound in a compartment of the vehicle, the dialog method includes: as steps to be executed by at least one processor, a dialog execution step of generating a conversational sentence toward the driver, and controlling the speech output unit to output the conversational sentence; a load determination step of determining whether a driving load on the driver is high with respect to a road where the vehicle travels; and an utterance control step of setting a forbidden state for forbidding from starting utterance in the dialog execution step when it is determined in the load determination step that the driving load is high, and setting a permitted state for permitting to start the utterance in the dialog execution step when it is determined in the load determination step that the driving load is low.

Also in the above-described dialog method, the situation of the driving load on the driver is considered. Therefore, with the configuration to execute the dialog method, it is possible to speak to the driver without interfering with the driver's driving operation.

Further, according to another aspect of the present disclosure, a dialog method for executing a dialog with a driver of a vehicle using a speech output unit that outputs a sound in a compartment of the vehicle, the dialog method includes: as steps to be executed by a processor of a remote server which is disposed outside the vehicle and connectable with the speech output unit via a communication network, a dialog execution step of generating a conversational sentence toward the driver, and controlling the speech output unit to output the conversational sentence; and an utterance control step of setting a forbidden state for forbidding from starting utterance in the dialog execution step when it is determined, in determining whether a driving load is high with respect to a road where the vehicle travels, that the driving load on the driver is high, and setting a permitted state for permitting to start the utterance in the dialog execution step when it is determined that the driving load is low. Also in this dialog method, the situation of the driving load on the driver is considered. Therefore, with the configuration to execute the dialog method, it is possible to speak to the driver without interfering with the driver's driving operation.

Moreover, according to another aspect of the present disclosure, there is provided a program for causing at least one processor to execute the above-described dialog method. The program may be provided via an electrical communication line, or may be provided as stored in a non-transitory storage medium.

### BRIEF DESCRIPTION OF DRAWINGS

The above and other objects, features and advantages of the present disclosure will become more apparent from the following detailed description made with reference to the accompanying drawings. In the drawings:

FIG. 1 is a block diagram showing an overall configuration of a dialog device according to an embodiment;

FIG. 2 is a diagram schematically showing the Yerkes-Dodson Law that explains a correlation between an arousal and driving performance of a driver;

FIG. 3 is a diagram explaining functional blocks constructed in a state information processing circuit;

FIG. 4 is a diagram explaining functional blocks constructed in a control circuit;

FIG. 5 is a flowchart showing, along with FIG. 6, conversation start processing that is executed in the control circuit;

FIG. 6 is a flowchart showing, along with FIG. 5, the conversation start processing that is executed in the control circuit;

FIG. 7 is a flowchart showing a modified example of the conversation start processing executed in the control circuit; and

FIG. 8 is a block diagram showing an overall configuration of a dialog system according to the modified example.

### EMBODIMENTS FOR CARRYING OUT INVENTION

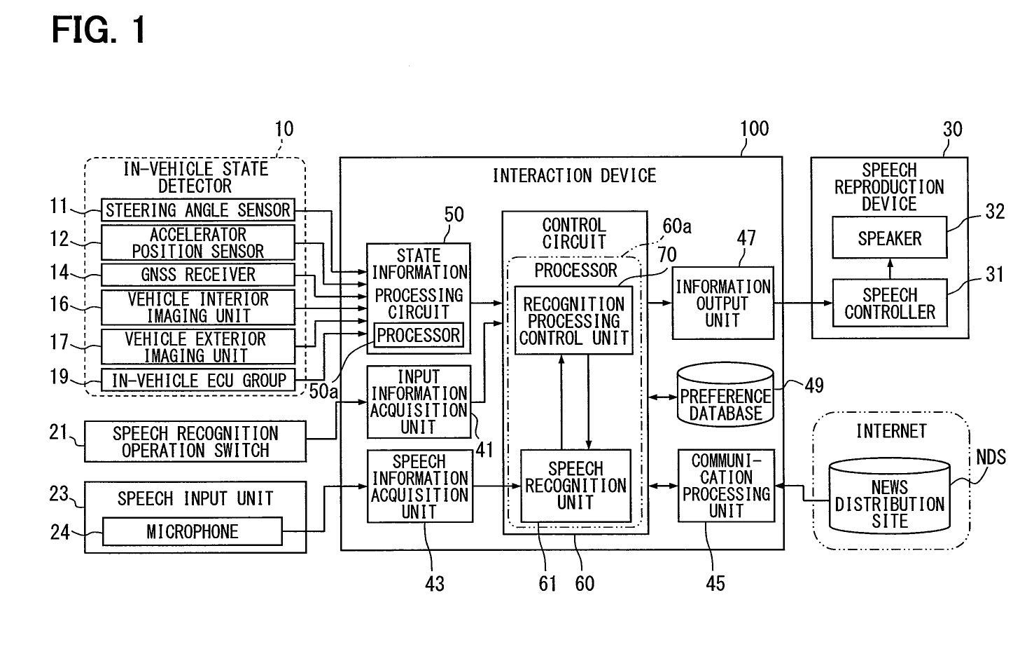

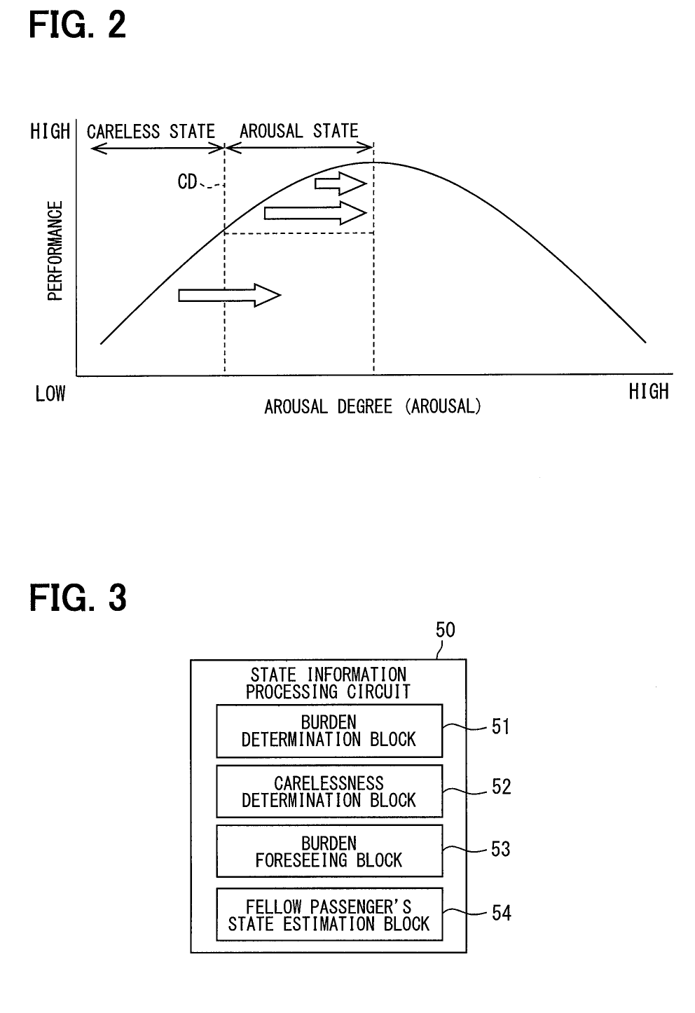

A dialog device 100 according to one embodiment shown in FIG. 1 is mounted in a vehicle and capable of having a conversation with a passenger of the vehicle. As shown in FIG. 2, the dialog device 100 is actively interactable with a driver among passengers of the vehicle. The dialog device 100 has a conversation with the driver so as to hold the driver in a normal arousal state where the driver can show high driving performance. Further, the dialog device 100 can play a role of eliminating the carelessness, which is to bring the arousal of the driver who has entered a careless state back into the normal arousal state by a conversation with the driver.

As shown in FIG. 1, the dialog device 100 is electrically connected with an in-vehicle state detector 10, a speech recognition operation switch 21, a speech input unit 23, and a speech reproduction device 30. Moreover, the dialog device 100 is connected to the Internet, and can acquire information from the outside of the vehicle through the Internet.

The in-vehicle state detector 10 is a variety of sensors and electronic equipment mounted in the vehicle. The in-vehicle state detector 10 includes at least a steering angle sensor 11, an accelerator position sensor 12, a GNSS receptor 14, a vehicle interior imaging unit 16, a vehicle exterior imaging unit 17, and an in-vehicle ECU (Electronic Control Unit) group 19.

The steering angle sensor 11 detects a steering angle of a steering wheel steered by the driver and outputs a detection result to the dialog device 100. The accelerator position sensor 12 detects an amount of pressing an accelerator pedal by the driver and outputs a detection result to the dialog device 100.

The GNSS (i.e., Global Navigation Satellite System) receptor 14 receives a positioning signal transmitted from a plurality of positioning satellites to acquire position information showing the current position of the vehicle. The GNSS receptor 14 outputs the acquired position information to the dialog device 100, a navigation ECU (described later), and the like.

The vehicle interior imaging unit 16 includes, for example, a near-infrared camera combined with a near-infrared light source. The near-infrared camera is installed in the vehicle interior and mainly shoots the driver's face by light applied from the near-infrared light source. By performing image analysis, the vehicle interior imaging unit 16 extracts from the shot image a direction of a visual line of the driver's eyes, opening conditions of the eyes (eyelids), and the like. The vehicle interior imaging unit 16 outputs information of the extracted direction of the driver's visual line, the extracted opening conditions of the eyes, and the like to the dialog device 100.

The vehicle interior imaging unit 16 may include a plurality of near-infrared cameras and visible light cameras, and the like. When the vehicle interior imaging unit 16 is made up of the plurality of cameras, the vehicle interior imaging unit 16 can shoot, for example, passengers seated on the passenger seat and the rear seat, as well as the driver's face and its periphery. Hence, the vehicle interior imaging unit 16 can also output state information of the passenger other than the driver to the dialog device 100 as fellow passenger's state information. Further, the vehicle interior imaging unit 16 can shoot a range other than the driver's face, for example, and detects movement of the hands and body.

The vehicle exterior imaging unit 17 is a visible light camera installed inside or outside the vehicle in a posture facing the surroundings of the vehicle, for example. The vehicle exterior imaging unit 17 shoots the surroundings of the vehicle which include at least the front of the vehicle. By performing image analysis, the vehicle exterior imaging unit 17 extracts a road shape in the traveling direction, road congestion conditions around the vehicle, and some other information from the shot images. The vehicle exterior imaging unit 17 outputs information showing the road shape, the congestion conditions, and the like to the dialog device 100. The vehicle exterior imaging unit 17 may include a plurality of visible light cameras, near-infrared cameras, distance image cameras, and the like.

The in-vehicle ECU group 19 includes ECUs each mainly made up of a microcomputer, and includes a brake control ECU, an integrated control ECU, a navigation ECU, and the like. For example, vehicle speed information is outputted from the brake control ECU so as to be acquirable by the dialog device 100. Fellow passenger's state information is outputted from the integrated control ECU, the information showing whether passengers are seated on the passenger seat and the rear sheet. Route information to a destination, set by the passenger, is outputted from the navigation ECU.

The speech recognition operation switch 21 is provided around the driver's seat. The passenger of the vehicle inputs, into the speech recognition operation switch 21, an operation for switching activation of a conversation function of the dialog device 100 between on and off. The speech recognition operation switch 21 outputs operation information, inputted by the passenger, to the dialog device 100. An operation of changing a set value concerning the conversation function of the dialog device 100 may be made inputtable into the speech recognition operation switch 21.

The speech input unit 23 includes a microphone 24 provided in the vehicle interior. The microphone 24 converts speech of a conversation uttered by the passenger of the vehicle into an electrical signal and outputs the converted signal as speech information to the dialog device 100. The microphone 24 may be configured for a phone call, being provided in communication equipment such as a smartphone or a tablet terminal. Further, speech data collected by the microphone 24 may be wirelessly transmitted to the dialog device 100.

The speech reproduction device 30 is a device having an output interface function of outputting information to the passenger. The speech reproduction device 30 includes a display unit, a speech controller 31, and a speaker 32. When the speech controller 31 acquires speech data of conversational sentences, the speech controller drives the speaker 32 on the basis of the acquired speech data. The speaker 32 is provided in the vehicle interior, and outputs speech in the vehicle interior. The speaker 32 reproduces conversational sentences such that the passengers including the driver in the vehicle can listen to the sentences.

The speech reproduction device 30 may be simple acoustic equipment, or may be a communication robot installed on the upper surface of an instrument panel, or the like. The communication equipment such as the smartphone or the tablet terminal connected to the dialog device 100 may serve as the speech reproduction device 30.

Next, the configuration of the dialog device 100 will be described. The dialog device 100 is made up of an input information acquisition unit 41, a speech information acquisition unit 43, a communication processing unit 45, an information output unit 47, a preference database 49, a state information processing circuit 50, a control circuit 60, and the like.

The input information acquisition unit 41 is connected with the speech recognition operation switch 21. The input information acquisition unit 41 acquires operation information outputted from the speech recognition operation switch 21 and provides the acquired operation information to the control circuit 60. The speech information acquisition unit 43 is an interface for inputting speech, connected with the microphone 24. The speech information acquisition unit 43 acquires speech information outputted from the microphone 24 and provides the acquired speech information to the control circuit 60.

The communication processing unit 45 includes an antenna for mobile communication. The communication processing unit 45 transmits and receives information to and from a base station outside the vehicle via the antenna. The communication processing unit 45 is connectable to the Internet through the base station. The communication processing unit 45 can acquire traffic jam information of the surroundings of the vehicle through the Internet, for example. The communication processing unit 45 can acquire, through the Internet, regional information such as popular spots and weather around the point where the vehicle is currently traveling. The communication processing unit 45 can acquire, from at least one or more search engines on the Internet, information of words having been searched a large number of times, and information relating to each of the words. The communication processing unit 45 can acquire news information from at least one or more news distribution sites (NDS) on the Internet. A plurality of pieces of news information acquired by the communication processing unit 45 each include, for example, a title of the news and a body text describing a detailed content of the news. The regional information, the information on words ranked high in search ranking, and the news information described above are stored into the preference database 49 as candidates for a content of a conversation to be executed by the dialog device 100.

The information output unit 47 is an interface that is connected with the speech reproduction device 30 and that outputs speech. The information output unit 47 outputs speech data, generated by the control circuit 60, to the speech reproduction device 30. The speech data outputted from the information output unit 47 is acquired by the speech controller 31 and reproduced by the speaker 32.

The preference database 49 is provided in a storage medium such as a flash memory connected to the control circuit 60. The preference database 49 preferentially stores information interesting for the driver. A preference category of the drive's preference is set by the control circuit 60 based on, for example, reaction of the driver to a conversation, the driver's direct input of a selected operation, and the like. Among a large number of pieces of news information acquired by the communication processing unit 45, those pieces of news information in the driver's preference category are particularly stored into the preference database 49. The news information, the regional information, the information on words ranked high in search ranking, and some other information, which are stored in the preference database 49, are referred to by the control circuit 60 that generates conversational sentences.

The state information processing circuit 50 acquires information outputted from the in-vehicle state detector 10 to estimate the state of the passengers including the driver. The state information processing circuit 50 is mainly made up of a microcomputer including a processor 50a, a RAM, and a flash memory. The state information processing circuit 50 is provided with a plurality of input interfaces that receive signals from the in-vehicle state detector 10. The state information processing circuit 50 constructs, as functional blocks, a load determination block 51, a load foreseeing block 53, a carelessness determination block 52, and a fellow passenger's state estimation block 54, shown in FIG. 3, by the processor 50a executing a predetermined program. Hereinafter, a detail of each functional block constructed in the state information processing circuit 50 will be described based on FIGS. 1 and 3.

The load determination block 51 determines whether the driving load on the driver is high on the road where the vehicle is currently driving. The load determination block 51 acquires detection results outputted from the steering angle sensor 11 and the accelerator position sensor 12 When the load determination block 51 estimates that the driver is busy in operating at least one of the steering and the accelerator pedal based on transition of the acquired detection results, the load determination block 51 determines that the current driving load is high.

Further, the load determination block 51 acquires shape information of the road where the vehicle is traveling, information showing congestion conditions around the vehicle, and some other information. The shape information of the road can be acquired from the vehicle exterior imaging unit 17 and the navigation ECU. The information showing the congestion conditions can be acquired from the vehicle exterior imaging unit 17 and the communication processing unit 45. When the road in the traveling direction has a curved shape and when the vehicle is estimated to be traveling in a traffic jam, the load determination block 51 determines that the current driving load is high.

On the other hand, when the vehicle is traveling on mostly a linear road and other traveling vehicles and pedestrians are small in number around the vehicle, the load determination block 51 determines that the current driving load is low. In addition, when the operating amounts of the steering and the accelerator pedal fluctuate slightly, the load determination block 51 can determine that the driving load is low.

The load foreseeing block 53 foresees a future increase in driving load associated with traveling continuation of the vehicle. The load foreseeing block 53 detects an event of increased driving load, which may occur in about several tens of seconds to one minute, for example. Specifically, the load foreseeing block 53 previously detects a case where the road in the traveling direction is curved, a case where a traffic jam has occurred in the traveling direction, a case where a right or left turn is informed by the navigation ECU, or some other case.

The carelessness determination block 52 determines whether the driver is in the careless state. The carelessness determination block 52 acquires detection results outputted from the steering angle sensor 11 and the accelerator position sensor 12 When the carelessness determination block 52 detects a careless operation on the steering or the accelerator pedal, an occasionally inputted large correction operation, or the like based on transition of the acquired detection results, the carelessness determination block 52 determines that the driver is in the careless state.

Further, the carelessness determination block 52 acquires, from the vehicle interior imaging unit 16, information such as a direction of a visual line of the driver's eyes and opening conditions of the eyes. When the parallax of the eyes is unstable or is not in an appropriate state for perception of an object in the traveling direction, and when the opening degree of the eyes continues to be low, the carelessness determination block 52 determines that the driver is in the careless state.

Moreover, when the load foreseeing block 53 foresees a future increase in driving load, the carelessness determination block 52 lowers a criterion of determination CD (cf. FIG. 2) for determining that the driver is in the careless state. As a result, prior to the occurrence of an event that increases the driving load, a period is set in which the carelessness determination block 52 tends to determine that the driver is in the careless state.

The fellow passenger's state estimation block 54 estimates the state of the passenger other than the driver. The fellow passenger's state estimation block 54 determines whether the passenger except the driver is in the vehicle, based on fellow passenger's state information acquired from the integrated control ECU. The fellow passenger's state estimation block 54 may not only make simple determination on the presence or absence of the fellow passenger, but also determine whether the passenger is asleep. Specifically, when the vehicle interior imaging unit 16 can extract state information of the fellow passenger other than the driver, the fellow passenger's state estimation block 54 can perform determination as to whether the passenger except the driver is asleep based on the fellow passenger's state information acquired from the vehicle interior imaging unit 16.

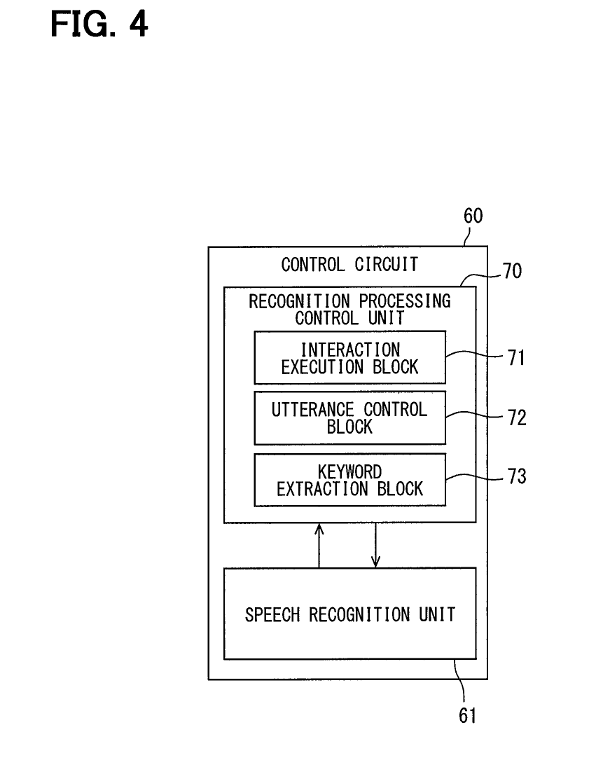

The control circuit 60 shown in FIG. 1 is a circuit that integrally controls a conversation exchanged with the passenger. The control circuit 60 is mainly made up of a microcomputer including a processor 60a, a RAM, and a flash memory. The control circuit 60 is provided with an input/output interface connected with other configurations of the dialog device 100. The control circuit 60 constructs, as functional blocks, a speech recognizer 61, and a recognition processing unit 70 including a keyword extraction block 73, a dialog execution block 71, and an utterance control block 72, as shown in FIG. 4, by the processor 60a executing a predetermined program. Hereinafter, a detail of each functional block constructed in the control circuit 60 will be described based on FIGS. 1 and 4.

The speech recognizer 61 is connected with the speech information acquisition unit 43 and acquires speech data from the speech information acquisition unit 43. The speech recognizer 61 reads the acquired speech data and converts the read data to text data. The speech recognizer 61 converts, into text data, words uttered by the passengers including the driver in the vehicle interior, such as a monologue of the driver and a conversation between the driver and the fellow passenger. The speech recognizer 61 then provides the text data to the recognition processing unit 70.

While acquiring the passengers' words converted into the text data from the speech recognizer 61, the recognition processing unit 70 outputs, to the information output unit 47, conversational sentences to be uttered to the passenger. In the recognition processing unit 70, conversational sentences to be uttered mainly to the driver are generated by the keyword extraction block 73, the dialog execution block 71, and the utterance control block 72.

The keyword extraction block 73 analyzes the words of the passengers uttered in the vehicle interior using the text data acquired from the speech recognizer 61, and extracts a previously set keyword. The keyword is set, for example, to a word ranked high in search ranking acquired by the communication processing unit 45. The keyword extraction block 73 can set as a keyword only a word relating to the driver's preference category among words ranked high in search ranking.

The dialog execution block 71 generates speech data of conversational sentences directed to the passengers including the driver. The dialog execution block 71 outputs the speech data of the conversational sentences from the information output unit 47 to the speech controller 31, to cause the speaker 32 to utter the conversational sentences. The dialog execution block 71 can create a variety of conversational sentences in accordance with situations of the vehicle and the driver and reaction of the driver.

Specifically, when the driver enters the careless state, the dialog execution block 71 can include regional information relating to the point where the vehicle is currently driving into the conversational sentences directed to the driver. Further, when the communication processing unit 45 acquires news information included in the driver's preference category, the dialog execution block 71 can include the content of this news information into the conversational sentences. Moreover, when the keyword extraction block 73 extracts a keyword, the dialog execution block 71 can include information relating to the extracted keyword into the conversational sentences.

The dialog execution block 71 synthesizes speech data of the conversational sentences, based on the generated text data of the conversational sentences. The dialog execution block 71 may perform syllable connection-type speech synthesis, or may perform corpus base-type speech synthesis. Specifically, the dialog execution block 71 generates rhythm data at the time of utterance from the conversational sentence text data. The dialog execution block 71 then joins pieces of speech waveform data from previously stored speech waveform database in accordance with the rhythm data. From the above process, the dialog execution block 71 can convert the conversational sentence text data to the speech data.

The utterance control block 72 controls execution of a conversation by the dialog execution block 71. For example, when an instruction to bring the conversation function of the dialog device 100 into an off-state by operation on the speech recognition operation switch 21, the utterance control block 72 brings the keyword extraction block 73 and the dialog execution block 71 into a stopped state. Further, the utterance control block 72 can previously set a preference category of the driver's preference and store news information corresponding to the preference category into the preference database 49.

Moreover, in accordance with load determination made by the load determination block 51, the utterance control block 72 switches an activation status of the dialog execution block 71 between a forbidden state and a permitted state. Specifically, when the load determination block 51 determines that the driving load is high, the dialog execution block 71 sets the activation status of the dialog execution block 71 in the forbidden state in which the start of utterance is forbidden. On the other hand, when the load determination block 51 determines that the driving load is low, the utterance control block 72 sets the activation status of the dialog execution block 71 in the permitted state in which the start of utterance is permitted.

Even when the load determination block 51 determines that the driving load is low, the utterance control block 72 does not set the activation status of the dialog execution block 71 in the permitted state, but holds it in the forbidden state, in the case that a previously set forbidding condition has been satisfied. The forbidding condition can be set as appropriate. For example, the utterance control block 72 can make the forbidding condition satisfied when the fellow passenger's state estimation block 54 has determined that the passenger other than the driver is in the vehicle interior. Alternatively, the utterance control block 72 can make the forbidding condition satisfied when the driver is talking on the phone with a person outside the vehicle by using a hand-free phone call function mounted in the vehicle.

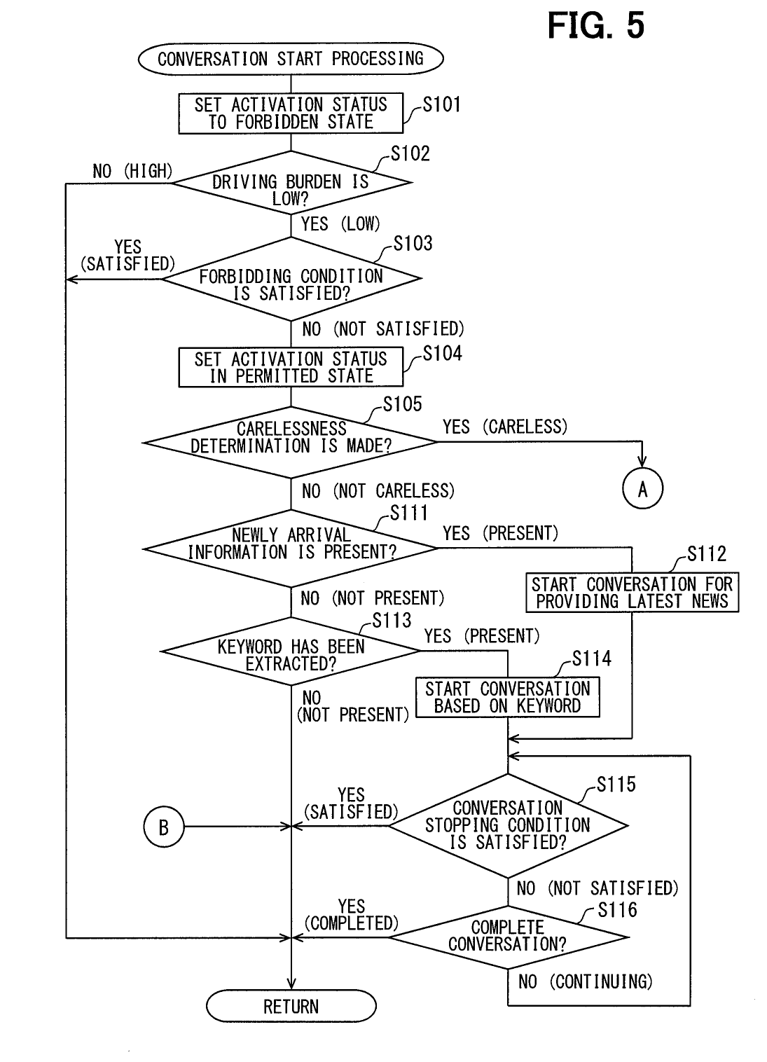

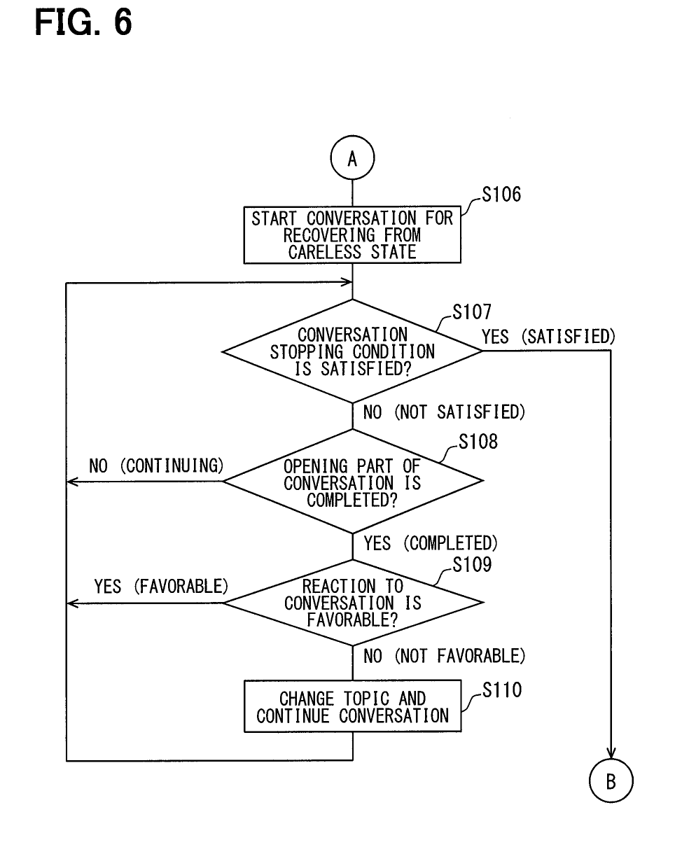

When the activation status of the dialog execution block 71 is in the permitted state, the utterance control block 72 can make a conversation start, with the occurrence of each of a variety of utterance starting events as a trigger, to make the arousal of the driver favorable. Examples of the utterance starting events include making of the carelessness determination, acquisition of news information, and extraction of a specific keyword. Hereinafter, a detail of the conversation start processing executed by the utterance control block 72 will be described based on FIGS. 5 and 6 with reference to FIG. 1. The conversation start processing shown in FIGS. 5 and 6 is started based on that the power of the vehicle is brought into the on-state, and is repeatedly started until the power of the vehicle is brought into the off-state.

In S101, as an initial setting, the activation status of the dialog execution block 71 is set in the forbidden state, and the processing proceeds to S102. In S102, a determination result of the load determination block 51 is acquired to determine whether the current driving load on the driver is low. When it is determined that the current driving load on the driver is high in S102, the conversation start processing is once ended. On the other hand, when it is determined that the driving load is low in S102, the processing proceeds to S103.

In S103, it is determined whether the forbidding condition has been satisfied. When it is determined that some forbidding condition has been satisfied in S103, the conversation start processing is once ended. On the other hand, when it is determined that any forbidding condition has not been satisfied in S103, the processing proceeds to S104.

In S104, the activation status of the dialog execution block 71 is switched from the forbidden state to the permitted state, and the processing proceeds to S105. In S105, the carelessness determination block 52 sees whether the carelessness determination on the driver has been made. When the driver is not in the careless state, the processing proceeds to S111. On the other hand, when the driver is in the careless state, the processing proceeds to S106. In S106, the processing is started to start a conversation for recovering the driver from the careless state, and the processing proceeds to S107.

In S107, it is determined whether a conversation stopping condition has been satisfied. Examples of the conversation stopping condition include a condition that the user has given utterance with instructions to end the conversation, a condition that the driving load on the user has become high, and a condition that the driver has recovered to a normal arousal state. When it is determined that the conversation stopping condition has been satisfied in S107, the conversation started in S106 is forcibly stopped, and the conversation start processing is once ended.

On the other hand, when it is determined that the conversation stopping condition has not been satisfied in S107, the processing proceeds to S108. In S108, it is determined whether an opening part of the conversation started in S106, such as introduction of a headline sentence, has been ended. When it is determined that the opening part of the conversation still continues in S108, standby is kept until the opening part is ended by repeating the determination of S107 and S108. When it is determined that the opening part of the conversation is ended in S108, the processing proceeds to S109.

In S109, for estimating whether a reaction of the driver to the opening part of the conversation is favorable, it is determined whether the careless state of the driver has been improved. When it is estimated that the reaction to the current conversation topic is favorable and the careless state has been improved in S109, repetition of S107 to S109 is made. Accordingly, the conversation that the driver is interested in is continued.

On the other hand, when it is estimated that the careless state has not been improved and the reaction of the driver to the current topic is not favorable in S109, the processing proceeds to S110. In S110, the topic is changed and the conversation with the driver is continued. Then, the processing returns to S107. According to S109 and S110, the conversation concerning news information that the driver is less interested in is ended quickly.

In S111, it is confirmed whether there is the latest news information in the driver's preference category. When there is no latest news information, the processing proceeds to S113. When there is the latest news information, the processing proceeds to S112. In S112, the processing is executed to start a conversation for providing the driver with the latest news information, and the processing proceeds to S115.

In S113, it is determined whether a specific keyword has been extracted from words uttered by the driver. When no keyword is extracted in S113, the conversation start processing is once ended. On the other hand, when the keyword is extracted in S113, the processing proceeds to S114. In S114, the processing is executed to start a conversation based on the keyword, and the processing proceeds to S115.

In S115, similarly to S107, it is determined whether the conversation stopping condition has been satisfied. When it is determined that the conversation stopping condition has been satisfied in S115, the conversation started in S112 or S114 is forcibly stopped, and the conversation start processing is once ended. On the other hand, when it is determined that the conversation stopping condition has not been satisfied in S115, the processing proceeds to S116. In S116, it is determined whether the conversation started in S112 or S114 has been completed. When it is determined that the conversation still continues in S116, standby is kept until the completion of the conversation by repeating the determination of S115 and S116. When it is determined that the conversation has been completed in S116, the conversation start processing is once ended.

A detail of each conversation started by the above conversation start processing will further be described. Immediately before the start of a series of conversation described below, the speaker 32 outputs a notification sound for notifying the driver that a conversation will be started by the dialog device 100. The notification sound can turn the awareness of the driver to the speech of the conversation. As a result, the driver hardly misses a beginning part of the conversation started by the dialog device 100.

In the opening of a series of conversational sentences started by the processing of S106, a message is incorporated to encourage the driver to be aware of the careless state. Further, regional information relating to the currently traveling point is provided by the conversation. Specifically, for recovering the driver from the careless state, the dialog execution block 71 generates such conversational sentences as follows:

Dialog device: “You seem to be bored. Why don't we talk about something?”

Driver: “Yes, let's.” Dialog device: “I hear that xxx served by a shop named ◯◯◯, located about 1 km north from here is tremendously popular these days.”

Driver: “Oh, that's interesting.”

Dialog device: “Its feature is including ΔΔΔ.”

Driver: “I feel like going there.”

Dialog device: “The shop opens from □□□ to □□□, and is closed on ∇∇∇, so you can make it now with no problem.”

As the conversation including the regional information, the dialog device 100 can execute a conversation that informs weather: “It will rain a little hard in about ◯◯◯ minutes”, or a conversation that informs a landmark: “A high building you can see on the left is ◯◯.”

In the opening of a series of conversational sentences started by the processing of S112, a headline sentence is incorporated to show a content of news information to be provided. This headline sentence may be a title added to the acquired news information, or may be sentences obtained by combining characteristic words extracted from a body text of the news information to summarize the content of the news information. Specifically, for providing the latest news information so as to hold the driver's arousal state, the dialog execution block 71 generates such conversational sentences as follows:

Dialog device: “I hear that Company xxx has announced a new version of ◯◯◯.”

Driver: “Oh, really? How it has changed?”

Dialog Device: “It seems that the function of ΔΔΔ has been enhanced to make ∇∇∇ almost automatic.”

Driver: “Is that so? I want to buy one.”

Dialog device: “It will be released on ◯◯/xx in Japan.”

In the opening of a series of conversational sentences started by the processing of S114, a keyword extracted from the conversation with the passenger is incorporated. Specifically, for developing a chat based on the keyword so as to hold the driver's arousal state, the dialog execution block 71 generates such conversational sentences as follows:

Dialog device: “Speaking of ‘◯◯◯ (keyword)’, do you know that ◯◯◯ used to be called ΔΔΔ?”

Driver: “No, I don't.”

Dialog device: “It was originally called ΔΔΔ after xxx.”

Driver: “Oh.”

Dialog device: “However, since it was easily mistaken for ∇∇∇, it has come to be called ◯◯◯ by everyone.”

Driver: “I see.”

Dialog device: “Then, ◯x◯, an imitation of ◯◯◯, has now appeared.”

Driver: “Really?”

As above, the dialog device 100 can develop the dialog with the driver.

According to the present embodiment described so far, the utterance of conversational sentences is permitted when the driving load on the driver is low, whereas the utterance of conversational sentences is forbidden when the driving load on the driver is high. As described above, by consideration of the situation of the driving load on the driver, the dialog device 100 can speak to the driver from the device side without interfering with the driver's driving operation.

According to the present embodiment, when the low driving load state continues, the driver easily enters the careless state. Hence, when a conversation is started by the determination that the driver is in the careless state, the conversation started by the dialog device 100 has the effect of bringing the driver back from the careless state to the normal arousal state, as well as the effect of not interfering with the driving operation of the driver.

According to the present embodiment, regional information relating to the current traveling point of the vehicle is provided by the conversation. This results in making the driver easily interested in the conversation started by the dialog device 100. Hence, the dialog device 100 can attract the driver to the content of the conversation and continue the conversation with the driver for a long time. With this configuration, the effect of bringing the driver back from the careless state to the arousal state by the conversation is exerted reliably.

According to the present embodiment, when a conversation is started based on detection of the careless state, a message that encourages the driver to be aware of the careless state is incorporated into the opening of the conversation. Then, the driver understands his or her own situation and can try to recover from the careless state by actively replying to the conversation started by the dialog device 100. With this configuration, the dialog device 100 can reliably exert the effect of encouraging the driver to make his or her own efforts and bringing the arousal of the driver back to the normal arousal state.

According to the present embodiment, when a future increase in driving load is foreseen, the criterion of determination CD for determining that the driver is in the careless state is lowered. With this configuration, the dialog device 100 offers a more active conversation to the driver having decreased its arousal and being slightly careless, thereby allowing the driver's arousal to previously increase in preparation for the future increase in driving load. As a result, the driver can afford to deal with an event that increases the driving load.

According to the present embodiment, when news information in the category that the driver is interested in is acquired in the permitted state with low driving load, a conversation is executed to convey the acquired news information. By speaking to the driver in such a manner, the dialog device 100 can appropriately exert the effect of holding the driver's arousal in the normal arousal state, the driver having the possibility to become careless due to continuation of the state where the driving load is low.

According to the present embodiment, a headline sentence is incorporated into the opening of a conversation that conveys news information. When the news information used for the conversation actually has a content that the driver is not interested in and there is thus no sign of improvement in the careless state, the dialog device 100 can quickly end the conversation with the driver concerning that news information and change the topic to different news information. As thus described, when the driver's uninterested response to introduction of the headline sentence can be detected and the topic can be changed, it is possible to reduce cases where the driver finds it vexing to be spoken to by the dialog device 100.

According to the present embodiment, the dialog device 100 can incorporate, into a conversation, information relating to a keyword uttered by the driver or the like, to start a conversation of a content that the driver is interested easily. With this configuration, the dialog device 100 can reliably exert the effect of attracting the driver to the content of the conversation started and enhancing the arousal of the driver.

According to the present embodiment, when a predetermined forbidding condition is satisfied, the forbidden state is held even when the driving load is low. With this configuration, the dialog device 100 can start a conversation with the driver while avoiding a situation not suitable for starting the conversation. For example, when the passenger other than the driver is in the vehicle interior, this passenger can be assumed to be asleep. Thus, when detecting the passenger, the dialog device 100 satisfies the forbidding condition to stop starting a conversation. With this configuration, cases are avoided where the start of an active conversation interferes with the sleep of the fellow passenger.

When the driver is talking on the phone with someone outside the vehicle, a conversation by the dialog device 100 can interfere with the phone call. Therefore, when the driver is having a talk on the phone, the dialog device 100 of the present embodiment satisfies the forbidding condition to stop starting a conversation. With this configuration, cases are avoided where the start of an active conversation prevents a phone call.

In the present embodiment, the speaker 32 corresponds to the “speech output unit”, and the communication processing unit 45 corresponds to the “information acquisition unit.” The load determination block 51 corresponds to the “load determination unit”, the carelessness determination block 52 corresponds to the “careless state determination unit”, and the load foreseeing block 53 corresponds to the “load foreseeing unit.” The dialog execution block 71 corresponds to the “dialog execution unit”, the utterance control block 72 corresponds to the “utterance control unit”, and the keyword extraction block 73 corresponds to the “keyword extraction unit.” S101 and S104 in the conversation start processing correspond to the utterance control step, S102 corresponds to the load determination step, and S106, S112, and S114 correspond to the “dialog execution step.”

### Other Embodiments

Although one embodiment has been illustrated above, the technical idea of the present disclosure can be realized as a variety of embodiments and a combination thereof.

In the above-described embodiment, detection of the careless state, reception of the latest news, and extraction of a keyword are set as a trigger for starting utterance by the dialog device. However, an event used as the trigger for starting utterance can be set as appropriate. For example, the dialog device can start a chat, with each of the following as a trigger: inputting by the driver who has become aware of the careless state into a dialog start switch provided around the driver's seat; speaking of words such as “Let's have a chat” by the driver; and some other event.

In the above-described embodiment, as the conversation for recovery from the careless state, the series of conversational sentences based on the regional information is illustrated. However, a variety of pieces of information can be employed to the conversation for recovery from the careless state so long as having contents that attract the driver's interest. For example, the dialog device can employ, to the conversation for recovery from the careless state, a piece of information that is not yet used in the conversation among a pieces of the latest news information relating to the preference category, a piece of information highly relating to the preference category among words ranked high in search ranking, and some other piece of information.

The dialog device of the above-described embodiment foresees the occurrence of an event that increases the driving load, and has a conversation that enhances the driver's arousal prior to the occurrence of the event. However, the conversation based on the foresight as above may not be executed. Further, it is preferable that the conversation based on the foresight of occurrence of the event be ended at least by the time immediately before the occurrence of the event. With this configuration, cases are avoided where a conversation for previously enhancing the arousal interferes with driving.

In the above-described embodiment, the latest news relating to the driver's preference category is selected and provided to the driver. However, the dialog device can exclude a piece of news information corresponding to the driver's dislike category among pieces of latest news information ranked high in access ranking, for example, and provide the driver with the remaining pieces of latest news information on a descending order.

In the above-described embodiment, the headline sentence, the keyword, or the like is incorporated into one sentence that is uttered first after reproduction of the notification sound. As thus described, the opening of the conversational sentences is principally the first sentence uttered first after reproduction of the notification sound. However, when a word being not particularly significant, such as “Hey” or “Well”, is inserted for drawing the attention of the driver and the like after reproduction of the notification sound, one sentence uttered after such a filled pause can correspond to the opening of the conversational sentences.

In the above-described embodiment, when the fellow passenger's state estimation block determines that the passenger other than the driver is in the vehicle interior, the utterance from the speaker has been stopped. However, in the case where it is possible to distinguish the state of the fellow passenger, specifically whether the fellow passenger is asleep, from an image captured by the vehicle interior imaging unit, the dialog device can start utterance from the speaker even when the fellow passenger who is not asleep is present. Moreover, the dialog device extracts a keyword from words uttered by the fellow passenger and then joins the conversation between the driver and the fellow passenger while having information relating to the keyword, thereby making it possible to further excite the conversation.

In the above-described embodiment, a plurality of forbidding conditions are set, and even if the driving load is low, the activation status of the dialog execution block is held in the forbidden state when the state corresponds to any of the forbidding conditions. Items to be set as such forbidding conditions are preferably changeable by an operation performed by the driver or the like. When the conversation function is easily stopped by input into the speech recognition operation switch, the forbidding conditions may not be provided.

In the above-described embodiment, the driver is determined to be in the careless state when small frequent correction of the steering is not inputted and rough correction of the steering is occasionally inputted or when the state of the driver's eyes is not stable. However, information that is used for determining the careless state can be changed as appropriate. For example, when traveling on a highway lasts for one hour or longer, the dialog device may estimate that the driver is in the careless state, based on vehicle speed information, information from the navigation ECU, and some other information. Moreover, when movements of the driver's hands and body are detectable by the in-vehicle camera, the careless state may be estimated based on such an action of the driver rubbing the eyes or the face with his or her hand or such an action of the driver frequently correcting his or her seated position and posture.

In the above-described embodiment, it is determined that the driving load is high when the operation on the steering or the accelerator pedal is busy or when the traveling road is curved or congested. However, information that is used for determining the driving load can be changed as appropriate. For example, the magnitude of the driving load on the driver may be determined based on bio-information of the driver such as his or her heart rate.

In the above-described embodiment, the detailed description has been given of the case where the dialog device 100 is having a non-task-oriented conversation with the aim at intersection itself. However, the dialog device 100 can have not only such a conversation as the chat described above, but also a task-oriented conversation, such as replying to a question asked by the passenger or making a reservation for a shop specified by the passenger. Further, during a non-task-oriented conversation, the task-oriented conversation can be inserted temporarily.

In the above-described embodiment, the carelessness determination block 52 determines whether the driver is in the careless state. As described above, the criterion of determination CD (cf. FIG. 2) for determining that the driver is in the careless state can be raised and lowered. Then, by using a plurality of values of the criterion of determination CD, the carelessness determination block 52 may determine the driver's carelessness level to be one of three or more levels. For example, by using two criterions of determination which are a high criterion of determination CD and a low criterion of determination CD, the carelessness determination block 52 may determine which is the driver's carelessness level among three levels, that is, a non-carelessness level, a low carelessness level (being in a daze), and a high carelessness level (being more in a daze).

The dialog execution block 71 may change an amount of conversational sentences, which the speech reproduction device 30 is caused to utter, in accordance with the driver's carelessness level. For example, the higher the driver's carelessness level, the smaller the amount of conversational sentences, which the speech reproduction device 30 is caused to utter, is made. As one example of methods for reducing utterance sentences, there is considered a method of analyzing modification relationship among generated conversational sentences and reducing modifying information. Alternatively, a priority is added to each of keywords in the sentences by using information of whether it is a keyword of a popular topic, thereby allowing step-by-step sentence reduction in accordance with the change in carelessness level. As a method for acquiring a keyword, there is, for example, a method of using a morphological analysis and fixed expression obtained by fixed expression extraction. Alternatively, a tfidf (term frequency−inverse document frequency) value may be calculated with respect to each word in the sentences and a word with a high score may be extracted as a keyword.

As conversational sentences which the speech reproduction device 30 is caused to utter, for example, the dialog execution block 71 generates such conversational sentences as follows:

Low carelessness level: “On ◯/◯, in a match between <Professional baseball team X> and <Professional team Z>, <Professional baseball player Y> in X played as a starter and went 4-for-5, winning a multi-hit award named ‘Modasho’.”

High carelessness level: “<Professional baseball player Y> won Modasho.”

As thus described, when the carelessness level is not lower than a predetermined level (e.g., the high level), keywords in the utterance may be narrowed to one (<Professional baseball player Y> in the above example). As the one keyword, for example, a word with the highest tfidf value may be employed. Although an existing proper name is naturally uttered in an actual conversation, the description of < . . . > as above is given in the present disclosure so as to avoid direct indication. With the above configuration, the dialog device 100 can cause the speech reproduction device 30 to utter an appropriate amount of conversational sentences in accordance with the driver's carelessness level.

The dialog execution block 71 may change the conversation start frequency, which is the frequency in start of a conversation, in accordance with the driver's carelessness level. For example, the higher the driver's carelessness level, the higher the conversation start frequency is made (the more frequently the conversation is started). Alternatively, the conversation start frequency may be increased when the state of the carelessness level being high continues, or when the effect of improving the carelessness level is on the decrease even though a conversation is taken place. For example, the conversation start frequency may be increased when the state of the carelessness level being not lower than a predetermined level (e.g., the low carelessness level) continues for not shorter than a threshold time. Alternatively, the conversation start frequency may be increased when the carelessness level is not improved even though a conversation is executed (started) not less than a threshold number of times. As one example of methods for changing the conversation start frequency, changing a conversation starting condition is considered. In the above-described embodiment, as the utterance starting event (the conversation starting condition), acquisition of fresh news information, extraction of a specific keyword, and the like have been illustrated. For changing the conversation starting condition, a condition for acquiring fresh news information, such as a period for defining “newness”, may be changed. Alternatively, a condition for extracting a specific keyword, such as a threshold of a tfidf value of a keyword to be extracted, may be changed. With the above configuration, the dialog device 100 can start a conversation with an appropriate conversation start frequency in accordance with the driver's carelessness level. For example, it is possible to prevent an increase in period in which the driver on the high carelessness level does not have a conversation, and thereby to prevent the driver's carelessness level from becoming higher during this period having no conversation and from reaching a level not capable of eliminating the carelessness by a conversation.

The conversation execution block 71 may change an utterance speed of conversational sentences of the speech reproduction device 30 in accordance with the driver's carelessness level. For example, the higher the driver's carelessness level, the more the utterance speed of the conversational sentences of the speech reproduction device 30 may be increased. As one example of methods for changing the utterance speed of conversational sentences, there is considered a method of using speech synthesis software that has the function of reading out a text by using synthesized speech, and changing the utterance speed of conversational sentences in conversational sentence speech data. In this case, the conversation execution block 71 may be configured to refer to a table specifying the utterance speed of each carelessness level. The utterance speed of each carelessness level may be changed by the user. With the above configuration, it is possible to cause reproduction of conversational sentences from the speech reproduction device 30 at an appropriate utterance speed in accordance with the driver's carelessness level. For example, the speech reproduction device 30 slowly utters conversational sentences to the driver in the careless state, and it is possible to prevent development of the carelessness (an increase in carelessness level) during this utterance.

The conversation execution block 71 may change a ringing mode of the speech reproduction device 30 at the start of the conversation in accordance with the driver's carelessness level, so that the driver easily notices the start of a conversation by the dialog device 100 (the conversation execution block 71). For example, the higher the driver's carelessness level, the more the reproduction volume may be increased for conversational sentences outputted from the speech reproduction device 30. Alternatively, there may be conducted such volume control that, the higher the driver's carelessness level, the more the volume may be decreased for reproduced sounds of the speech reproduction device 30 other than conversational sentences of the dialog device 100. The reproduced sounds of the speech reproduction device 30 includes music reproduction, radio output, and the like. For example, when the driver's carelessness level is not lower than a predetermined level (e.g., the low carelessness level), music and radio output may be muted. Alternatively, when the driver's carelessness level is not lower than a predetermined level (e.g., the low carelessness level), reproduction may be made as if conversational sentences provided by the dialog device 100 are being uttered in the driver's ears by using the sound image localization technique. Specifically, speech data for conversational sentences is processed such that sounds and images of conversational sentences reproduced from the speech reproduction device 30 are located around a headrest of the driver's seat With the above configuration, a conversation by the dialog device 100 is started in an appropriate ringing mode in accordance with the driver's carelessness level, thereby allowing the driver to easily notice the start of the conversation.

In the above, the description has been given of the example where the amount of conversational sentences, which the speech reproduction device 30 is caused to utter, is changed in accordance with the carelessness level. However, the amount of conversational sentence, which the speech reproduction device 30 is caused to utter, may be changed in accordance with the driver's driving load level. For example, the higher the driver's driving load level, the smaller the amount of conversational sentences, which the speech reproduction device 30 is caused to utter, is made. As the method for reducing utterance sentences, it is possible to employ the above-mentioned reduction method used in the configuration to change the amount of utterance of conversational sentences in accordance with the carelessness level. With the above configuration, the dialog device 100 can cause the speech reproduction device 30 to utter an appropriate amount of conversational sentences in accordance with the driver's driving load level. For example, it is possible to have a simple conversation, not a difficult conversation, with the driver on the high load level (the driver being busy in driving).

As a method for estimating the driver's load level, a variety of methods can be employed. For example, the load determination block 51 can determine the driver's driving load level in accordance with a driving scene including a road where the vehicle is currently driving. For example, when the vehicle is traveling on a highway, the driver's driving load level is determined to be a low level. When the vehicle is traveling at an intersection, the driver's driving load level is determined to be an intermediate level. When the vehicle is traveling on a road (street) passing through an urban area, the driver's driving load level is determined to be a high level. When it is raining or snowing, the driver's driving load level may be determined to be higher by one level than when it is fine. The driver's driving load level can also be determined based on the frequency in driving operation (acceleration operation, braking operation, steering, etc.). For example, the frequency in driving operation may be obtained from the number of times of driving operations or driving operation continuation time in a predetermined period up to the current point in time, and this frequency may be compared with a plurality of thresholds, to determine the driving load level to be one of several levels. The driver's driving load level can also be determined based on the driver's action (safety confirmation of the surroundings, an operation of equipment such as blinkers, etc.) For example, the action frequency may be obtained from the number of times and continuation time of the driver's actions in a predetermined period up to the current point in time, and this frequency may be compared with a plurality of thresholds, to determine the driving load level. Examples of the driver's actions include safety confirmation of the surroundings, an operation of equipment such as blinkers, etc.). As one example of techniques for detecting safety confirmation of the surroundings, there is a known technique of detecting movement of the driver's visual line from a captured image of the camera of the vehicle interior imaging unit 16, and detecting safety confirmation of the surroundings of the driver based on the movement of the visual line.

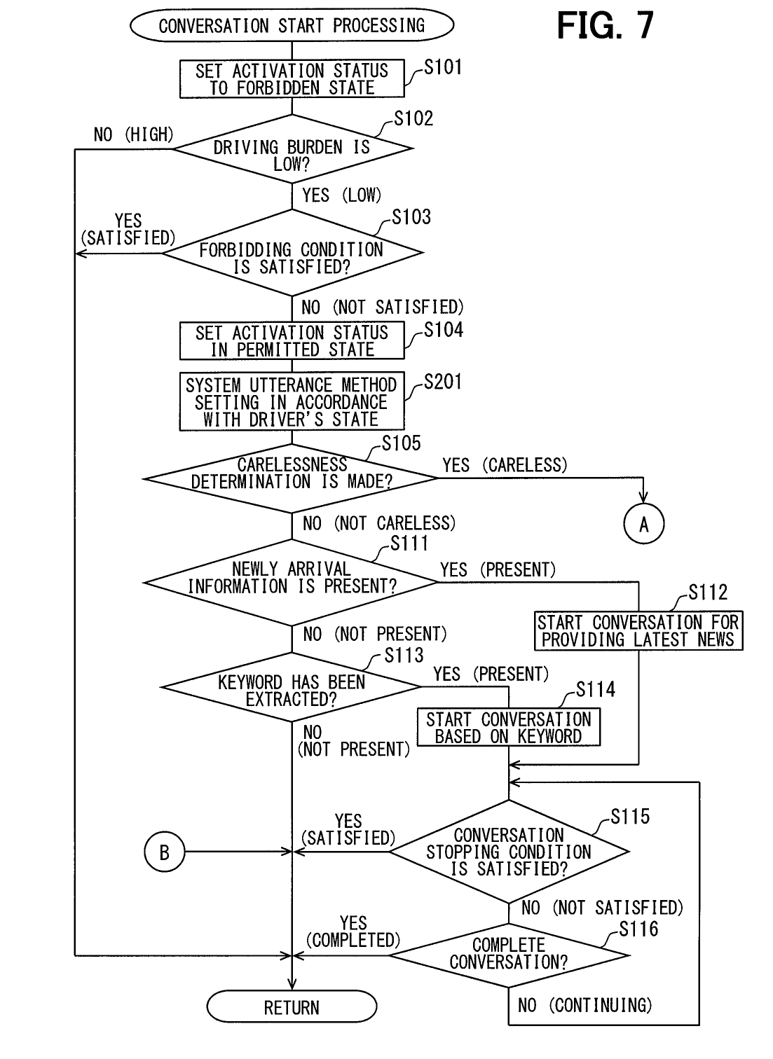

The settings for the system utterance method (the amount of utterance, the conversation frequency, the conversation tempo (conversation speed), the ringing mode at the start of conversation) in accordance with the driver's state (the carelessness level, the load level) may be executed in Step S201 that is executed between S104 and S105 as shown in FIG. 7. In S102, it may be determined whether the load level is lower than a predetermined level (e.g., the high load level). In S104, it may be determined whether the careless level is higher than a predetermined level (e.g., the non-carelessness level).

In the above-described embodiment, the functions provided by the respective processors 50a, 60a of the state information processing circuit 50 and the control circuit 60, such as the load determination, the carelessness determination, the dialog execution, and the utterance control, may be realized by a dedicated integrated circuit, for example. Alternatively, one processor may execute all of the load determination, the carelessness determination, the dialog execution, the utterance control, and the like, or different processors may respectively execute the load determination, the carelessness determination, the dialog execution, the utterance control, and the like. Each of the functions may be provided by hardware or software different from the above, or a combination of these. Further, the storage medium that stores a program to be executed by each of the processors 50a, 60a is not restricted to the flash memory. A variety of non-transitive substantive storage medium can be employed as a configuration to store the program.

The technical idea of the present disclosure is applicable not only to the dialog device mounted in the vehicle, but also to communication equipment such as a smart phone and a tablet terminal and a dialog program to be installed into a server outside the vehicle. A dialog method performed in each of the communication equipment, the server, and the like which execute the dialog program is substantially the same as the dialog method performed by the dialog device. For example, the dialog program is stored in a storage medium of a communication terminal, which is brought into the vehicle, as an application executable by the processor. The communication terminal can interact with the driver in accordance with the dialog program, and can hold the driver's arousal state through the dialog.

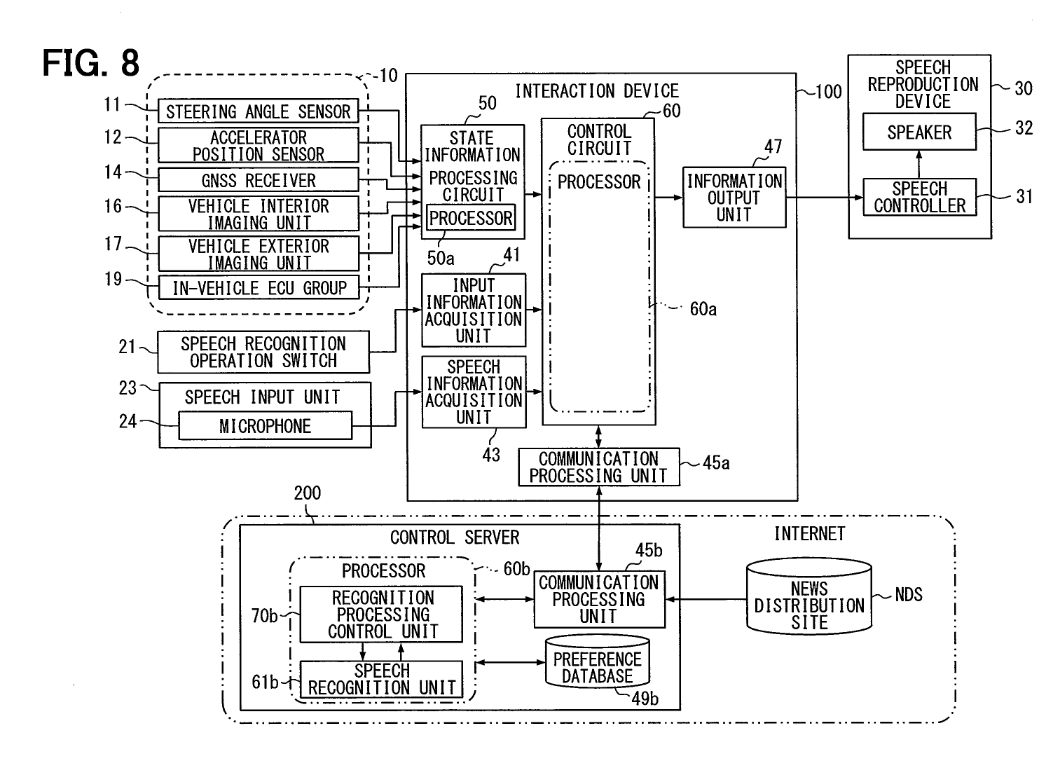

When the dialog program is stored in the storage medium of the server, the server can acquire state information of the vehicle and the driver through the Internet. Further, the server can transmit conversational sentences, generated based on the acquired state information, to the speech reproduction device of the vehicle and reproduce the generated conversational sentences from the speaker. FIG. 8 is a block diagram showing an overall configuration of a dialog system according to this modified example. Since a basic configuration of the modified example is similar to that of the above embodiment, description of the common configuration is omitted by referring to the preceding description, and different points will be mainly described. Note that the same symbol as that in the above-described embodiment shows the same configuration.

In the above-described embodiment, the dialog device 100 constructs the speech recognizer 61 and the recognition processing control unit 70 as the functional blocks, by execution of a predetermined program by the processor 60a of the dialog device 100. In contrast, in the modified example, a control server 200 constructs a speech recognizer 61b and a recognition processing control unit 70b as the functional blocks, by execution of a predetermined program by a processor 60b of the control server 200. That is, the speech recognizer 61b and the recognition processing control unit 70b provided in the remote control server 200 are configurations (clouds) that substitute for the speech recognizer 61 and the recognition processing control unit 70 of the dialog device 100 in the above-described embodiment. Accordingly, a communication processing unit 45b of the control server 200 acquires information required for processing of the speech recognizer 61b and the recognition processing control unit 70b via the communication network such as the Internet, and transmits data of the generated conversational sentences to the communication processing unit 45a of the dialog device 100, to reproduce the data from the speech reproduction device 30. Specifically, the communication processing unit 45b of the control server 200 acquires content information from a news distribution site (NDS) or the like, and stores the acquired information into a preference database 49b in the control server 200. Further, a variety of pieces of information such as the state information of the vehicle and the driver, having been inputted into the control unit 60 from the state information processing circuit 50, the input information acquisition unit 41, and the speech information acquisition unit 43 of the dialog device 100 in the above-described embodiment, are acquired from the dialog device 100. Data of conversational sentences that is generated based on the information as thus acquired and is directed to the driver is transmitted from the communication processing unit 45b of the control server 200 to the communication processing unit 45a of the dialog device 100 via the communication network. In FIG. 8, the configuration has been illustrated where the control server 200 is provided with the speech recognizer 61b and the recognition processing control unit 70b. However, the control server may be provided with some function of the speech recognizer and the recognition processing control unit and the dialog device may be provided with the other function. For example, the dialog device may be provided with the speech recognition unit, and the control server may be provided with the recognition processing control unit. Further, some or all of the functions of the functional blocks 51, 52, 53, and 54 (cf. FIG. 3) constructed by the state information processing circuit 50 in the above-described embodiment may be constructed by the processor 60b of the control server 200. In this case, the control server 200 may acquire, from the dialog device 100, information required for processing of these functional blocks (the information inputted from the in-vehicle state detector 10 into the state information processing circuit 50 in the above-described embodiment, and some other information).

As described above, even when the dialog program is installed in the server, a conversation between the driver and the system can be achieved. Even the server-type dialog system can hold the driver's arousal state.

The technical idea of the present disclosure is also applicable to a dialog device mounted in a vehicle that performs automatic driving (an autonomous traveling vehicle). For example, there is assumed automatic driving on an automated level where “a driving system automated in a specific driving mode performs an operation to drive a vehicle under a condition that the driver appropriately meets a driving operation switching request from the driving system.” In such an automatically driving vehicle, the driver (operator) needs to be held in a standby state for backup of the driving operation. It is thus presumed that the driver in the standby state easily enters the careless state. Accordingly, the dialog device as thus described is preferable also for the configuration to hold the arousal of the driver who is in the standby state as the backup of the automatic driving system.

Although the variety of embodiments and modified examples according to the present disclosure have been illustrated above, an embodiment obtained by appropriately combining the respective technical elements of these embodiments and modified examples is also an embodiment of the present disclosure.

What is claimed is:

1-24. (canceled)

25. A dialog device that is mounted in a vehicle together with a speech output unit for outputting a sound in a compartment of the vehicle, and executes a dialog with a driver of the vehicle, the dialog device comprising:
a dialog execution unit that generates a conversational sentence toward the driver, and controls the speech output unit to outputs the conversational sentence;
a load determination unit that determines whether a driving load on the driver is high with respect to a road where the vehicle travels;
an utterance control unit that sets a forbidden state for forbidding the dialog execution unit from starting utterance, and sets a permitted state for permitting the dialog execution unit to start the utterance when the load determination unit determines that the driving load is low; and
an information acquisition unit that acquires news information, as a candidate for a content of the conversation executed by the dialog execution unit, from an external device of the vehicle, wherein:
the utterance control unit
preliminarily sets a category of the news information, that the driver is interested in, as a preference category, and
controls the dialog execution unit to start the conversation for notifying the news information when the information acquisition unit acquires the news information in the preference category.

26. The dialog device according to claim 25, wherein:
the dialog execution unit incorporates a headline sentence showing a content of the news information into an opening of the conversational sentence when starting a conversation based on an acquisition of the news information.

27. The dialog device according to claim 25, wherein:
the utterance control unit maintains the forbidden state when a predetermined forbidding condition is established although the load determination unit determines that the driving load is low.

28. The dialog device according to claim 27, wherein:
the utterance control unit establishes the forbidding condition when a passenger other than the driver is disposed in the compartment.

29. A dialog device that is mounted in a vehicle together with a speech output unit for outputting a sound in a compartment of the vehicle, and executes a dialog with a driver of the vehicle, the dialog device comprising:
a dialog execution unit that generates a conversational sentence toward the driver, and controls the speech output unit to outputs the conversational sentence;
a load determination unit that determines whether a driving load on the driver is high with respect to a road where the vehicle travels; and
an utterance control unit that sets a forbidden state for forbidding the dialog execution unit from starting utterance, and sets a permitted state for permitting the dialog execution unit to start the utterance when the load determination unit determines that the driving load is low, wherein:
the utterance control unit maintains the forbidden state when a predetermined forbidding condition is established although the load determination unit determines that the driving load is low; and
the utterance control unit establishes the forbidding condition when a passenger other than the driver is disposed in the compartment.

30. The dialog device according to claim 28, wherein:
the utterance control unit establishes the forbidding condition when the driver talks on a phone with a person outside the vehicle.

31. A dialog device that is mounted in a vehicle together with a speech output unit for outputting a sound in a compartment of the vehicle, and executes a dialog with a driver of the vehicle, the dialog device comprising:
a dialog execution unit that generates a conversational sentence toward the driver, and controls the speech output unit to outputs the conversational sentence;
a load determination unit that determines whether a driving load on the driver is high with respect to a road where the vehicle travels; and
an utterance control unit that sets a forbidden state for forbidding the dialog execution unit from starting utterance, and sets a permitted state for permitting the dialog execution unit to start the utterance when the load determination unit determines that the driving load is low, wherein:
the utterance control unit maintains the forbidden state when a predetermined forbidding condition is established although the load determination unit determines that the driving load is low; and
the utterance control unit establishes the forbidding condition when the driver talks on a phone with a person outside the vehicle.

32. The dialog device according to claim 25, further comprising:
a careless state determination unit that determines whether the driver is in a careless state, wherein:
the utterance control unit controls the dialog execution unit to start a conversation toward the driver when the utterance control unit sets the permitted state and the careless state determination unit determines that the driver is in the careless state.

33. The dialog device according to claim 32, wherein:
in the conversation that is started based on a carelessness determination executed by the careless state determination unit, the dialog execution unit provides information relating to a current traveling point of the vehicle.

34. The dialog device according to claim 32, wherein:
the dialog execution unit incorporates a message, which encourages the driver to be aware of the careless state, into an opening of the conversational sentence when the conversation is started based on the carelessness determination executed by the careless state determination unit.

35. The dialog device according to claim 32, further comprising
a load predicting unit that predicts a future increase in the driving load in association with a continuation of travelling the vehicle, wherein:
the careless state determination unit reduces a criterion of determination (CD) for determining that the driver is in the careless state when the load predicting unit predicts the future increase in the driving load.

36. The dialog device according to claim 32, wherein:
the careless state determination unit further determines whether the careless state of the driver is improved after starting the conversation based on the carelessness determination; and
the dialog execution unit continues the conversation while changing a topic when the carelessness determination unit determines that the careless state of the driver is not improved.

37. The dialog device according to claim 25, further comprising:
a keyword extraction unit that analyzes a phrase spoken by a passenger of the vehicle including the driver in the compartment, and extracts a predetermined keyword, wherein:
the utterance control unit controls the dialog execution unit to start the conversation relating to the predetermined keyword when the utterance control unit sets the permitted state and the keyword extraction unit extracts the keyword.

38. The dialog device according to claim 37, wherein:
the dialog execution unit incorporates the predetermined keyword into the opening of the conversational sentence when starting the conversation based on an extraction of the predetermined keyword.

39. The dialog device according to claim 25, wherein:
the dialog execution unit changes an amount of the conversational sentence, which is output from the speech output unit, in accordance with a carelessness level of the driver.

40. The dialog device according to claim 25, wherein:
the dialog execution unit changes a conversation start frequency, which is a frequency of starting the conversation via the dialog execution unit, in accordance with a carelessness level of the driver.

41. The dialog device according to claim 25, wherein:
the dialog execution unit changes an utterance speed of the conversational sentence of the speech output unit in accordance with a carelessness level of the driver.

42. The dialog device according to claim 25, wherein:
the dialog execution unit changes an amount of the conversational sentence, which is output from the speech output unit, in accordance with a driving load level of the driver.

43. The dialog device according to claim 25, wherein:
the dialog execution unit changes a ringing mode of the speech output unit at a start of the conversation in accordance with a carelessness level of the driver to notice easily, for the driver, a start of the conversation via the dialog execution unit.

44. A dialog method for executing a dialog with a driver of a vehicle using a speech output unit that outputs a sound in a compartment of the vehicle, the dialog method comprising: as steps to be executed by at least one processor,
a dialog execution step of generating a conversational sentence toward the driver, and controlling the speech output unit to output the conversational sentence;
a load determination step of determining whether a driving load on the driver is high with respect to a road where the vehicle travels;
an utterance control step of setting a forbidden state for forbidding from starting utterance in the dialog execution step when it is determined in the load determination step that the driving load is high, and setting a permitted state for permitting to start the utterance in the dialog execution step when it is determined in the load determination step that the driving load is low; and
an information acquisition step of acquiring news information, as a candidate for a content of the conversation executed in the dialog execution step, from an external device of the vehicle, wherein:
the utterance control step further includes:
preliminarily setting a category of the news information, that the driver is interested in, as a preference category; and
starting the conversation for notifying the news information in the dialog execution step when the news information in the preference category is acquired in the information acquisition step.

45. A dialog method for executing a dialog with a driver of a vehicle using a speech output unit that outputs a sound in a compartment of the vehicle, the dialog method comprising: as steps to be executed by at least one processor,
a dialog execution step of generating a conversational sentence toward the driver, and controlling the speech output unit to output the conversational sentence;
a load determination step of determining whether a driving load on the driver is high with respect to a road where the vehicle travels; and
an utterance control step of setting a forbidden state for forbidding from starting utterance in the dialog execution step when it is determined in the load determination step that the driving load is high, and setting a permitted state for permitting to start the utterance in the dialog execution step when it is determined in the load determination step that the driving load is low, wherein:
the utterance control step further includes:
maintaining the forbidden state when a predetermined forbidding condition is established although it is determined in the load determination step that the driving load is low; and
establishing the forbidding condition when a passenger other than the driver is disposed in the compartment.

46. A dialog method for executing a dialog with a driver of a vehicle using a speech output unit that outputs a sound in a compartment of the vehicle, the dialog method comprising: as steps to be executed by at least one processor,
a dialog execution step of generating a conversational sentence toward the driver, and controlling the speech output unit to output the conversational sentence;
a load determination step of determining whether a driving load on the driver is high with respect to a road where the vehicle travels; and
an utterance control step of setting a forbidden state for forbidding from starting utterance in the dialog execution step when it is determined in the load determination step that the driving load is high, and setting a permitted state for permitting to start the utterance in the dialog execution step when it is determined in the load determination step that the driving load is low, wherein:
the utterance control step further includes:
maintaining the forbidden state when a predetermined forbidding condition is established although it is determined in the load determination step that the driving load is low; and
establishing the forbidding condition when the driver talks on a phone with a person outside the vehicle.

47. A dialog method for executing a dialog with a driver of a vehicle using a speech output unit that outputs a sound in a compartment of the vehicle,
the dialog method comprising: as steps to be executed by a processor of a remote server which is disposed outside the vehicle and connectable with the speech output unit via a communication network,
a dialog execution step of generating a conversational sentence toward the driver, and controlling the speech output unit to output the conversational sentence;
an utterance control step of setting a forbidden state for forbidding from starting utterance in the dialog execution step when it is determined, in determining whether a driving load is high with respect to a road where the vehicle travels, that the driving load on the driver is high, and setting a permitted state for permitting to start the utterance in the dialog execution step when it is determined that the driving load is low; and
an information acquisition step of acquiring news information, as a candidate for a content of the conversation executed in the dialog execution step, from an external device of the vehicle, wherein:
the utterance control step further includes:
preliminarily setting a category of the news information, that the driver is interested in, as a preference category; and
starting the conversation for notifying the news information in the dialog execution step when the news information in the preference category is acquired in the information acquisition step.

48. A dialog device comprising:
a communication processing unit that receives data of a conversational sentence toward a driver via a communication network, the conversational sentence generated by a remote server having a processor for executing the dialog execution step and the utterance control step according to claim 47; and
an information output unit that outputs the data of the conversational sentence toward the driver to a speech output unit, the data received by the communication processing unit.

49. A dialog system comprising:
a remote server having a processor for executing the dialog execution step and the utterance control step according to claim 47; and
a dialog device including
a communication processing unit that receives data of a conversational sentence toward the driver via a communication network, the conversational sentence generated by the remote server, and
an information output unit that outputs the data of the conversational sentence toward the driver to a speech output unit, the data received by the communication processing unit.

50. A program for executing the dialog execution step and the utterance control step according to claim 44 in the at least one processor.

51. The program according to claim 50, wherein:
the program is an application executable in a communication terminal.
